(19) United States
(12) Patent Application Publication
(10) Pub. No.: US 2023/0280987 A1
(43) Pub. Date: Sep. 7, 2023

(54) SYSTEM AND METHOD FOR CONTROLLING EXECUTION OF CALL STACK FRAMES

(71) Applicant: Damian KRYSTKIEWICZ, South Brisbane (AU)

(72) Inventor: Damian KRYSTKIEWICZ, South Brisbane (AU)

(21) Appl. No.: 18/100,989

(22) Filed: Jan. 24, 2023

Related U.S. Application Data
(60) Provisional application No. 63/315,539, filed on Mar. 2, 2022.

(51) Int. Cl. G06F 8/40

(52) U.S. Cl. CPC G06F 8/40

(57) ABSTRACT

A method for controlling execution of call stack frames within an actively running computer application includes adding at least one frame controlling instruction to modify behaviour of the code in such that a stack frame executing the code can be controlled on demand. Additionally, bytecode offsets to line numbers mapping manipulation is performed to conceal added instructions and match the original source code. The method allows stack frame operations including, but not limited to, restarting stack frames, creating new stack frames, dropping stack frames, handling software developer errors, halting stack frames.

### CROSS-REFERENCE TO RELATED APPLICATION

This application is related to and claims priority under 35 U.S.C. § 119(e) to U.S. Patent Application No. 63/315,539, filed Mar. 2, 2022, entitled “METHOD FOR CONTROLLING EXECUTION OF CALL STACK FRAMES,” the entire contents of which are incorporated herein by reference.

### FIELD

A system and method for controlling execution of call stack frames provides the ability to control call stack frames execution during computer program runtime.

To be more specific, the system and method perform call stack control actions such as frame restarting, frame dropping, frame halting, and others.

### BACKGROUND

Computer programs have predefined execution flow that is controlled by code instructions. Debuggers have been used to help find software errors easier and faster by allowing software developers to execute code instructions step by step and interact with the running computer program. Modern debuggers allow changing execution flow using unconditional jumps. In most cases execution flow changes are restricted to changing program pointer position inside the current call stack frame, therefore only limited debugging scenarios are possible.

During execution of function code it is desirable to have a way to restart the corresponding call stack frame in order to re-execute the code when needed. Re-executing code can be used to track down errors or to execute code step by step to examine behaviour of the function. It is also desirable to be able to drop a call stack frame allowing to reverse execution flow to further examine the program.

Currently known Dynamic Software Update techniques allow updating computer code while a program is running which can be beneficial during debugging or program runtime. Although the code can be updated, most programming language implementations prohibit updating code being currently executed on the call stack frame. To observe code changes a new call stack frame with updated code has to be created. Therefore, there is a need to control execution of call stack frames allowing to execute updated code within the call stack frames on demand.

CPython is the reference and the most widely used implementation of the Python programming language. CPython can be defined as an interpreter and a compiler as it is capable of compiling Python code into bytecode before interpreting it.

In CPython implementation, modules, classes, functions, and methods hold code objects which comprise bytecode, offsets to line numbers mapping, and other execution data. The code objects can be replaced during program execution runtime to change execution behaviour.

CPython implementation lacks native support for controlling stack frames, therefore controlling execution of stack frames is not trivial to achieve.

### SUMMARY

The system and method includes adding frame controlling instructions to the original code instructions and can be applied to any implementation of any programming language. Because of popularity of Python programming language, CPython implementation will be used to demonstrate examples.

In one example the instructions are added to the source code prior to compilation. In another example, the corresponding bytecode instructions are added to bytecode resulting in compilation of the original source code. In yet another example, the frame controlling instructions are added to a corresponding abstract syntax tree of the source code. Transforming the abstract syntax tree in order to add additional instructions is analogue to transforming source code and can be done by a person skilled in the art. Following are some alternative examples but not an exhaustive list to achieve adding frame controlling instructions.

Frame controlling instructions can be added anywhere in the bytecode. Additionally, the instructions can be conditionally disabled during regular execution flow to prevent unwanted behaviour or adding unnecessary execution time. In an example, the frame controlling instructions are added automatically by the handler process or development environment.

In one example, the frame controlling instructions comprise frame restarting instructions. Frame restarting is a desired functionality that allows restarting a call stack frame on demand with existing or updated code. Implementation of the functionality may comprise a recursive call executing the code within the current stack frame. Additionally, the updated code can be transformed by the system to enable subsequent frame controlling.

Additionally, execution errors of the new code can be handled by halting execution during frame restarting allowing software engineers to correct any source code mistakes or errors.

In another example, the frame controlling instructions comprise a return statement in order to implement returning from a current frame effectively dropping the frame from the call stack.

In yet another example, the frame controlling instructions perform calls to external libraries or other services like databases further controlling behaviour of the program. Any instructions implementing certain behaviour can be added with the methods of the present system.

Executing frame controlling instructions can be achieved by performing one or more unconditional jumps to locations of the instructions during execution of the frame.

Implementations of managing the frame controlling can include, but are not limited to, a handler process or a trace function.

### BRIEF DESCRIPTION OF THE DRAWINGS

FIG. 1 shows an exemplary transformation of function code according to an example of the instant disclosure.

FIG. 2 shows an exemplary transformation of function code in detail according to an example of the instant disclosure.

FIG. 3 depicts exemplary flow of execution of transformed code according to an example of the instant disclosure.

FIG. 4 shows an exemplary execution of a transformed function according to an example of the instant disclosure.

FIG. 5 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not Intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

As an example, the system for controlling execution of call stack frames in an actively running computing machine, includes a memory storing computer-readable instructions and at least one processor to execute the instructions to transform code instructions by adding at least one frame controlling instruction, perform an unconditional jump to a frame controlling instructions location, and execute the at least one frame controlling instruction, whereby execution of the frame controlling instructions one of perform and assist controlling execution of call stack frames.

The following description presents illustrative embodiments of the system and method.

CPython implementation of Python programming language is to present example and keywords specific to the programming language are written in italics.

In order to make code objects able to control the execution of call stack frames, the original code instructions are transformed. The transformation can be applied to including, but not limited to, modules, classes, functions, or methods code.

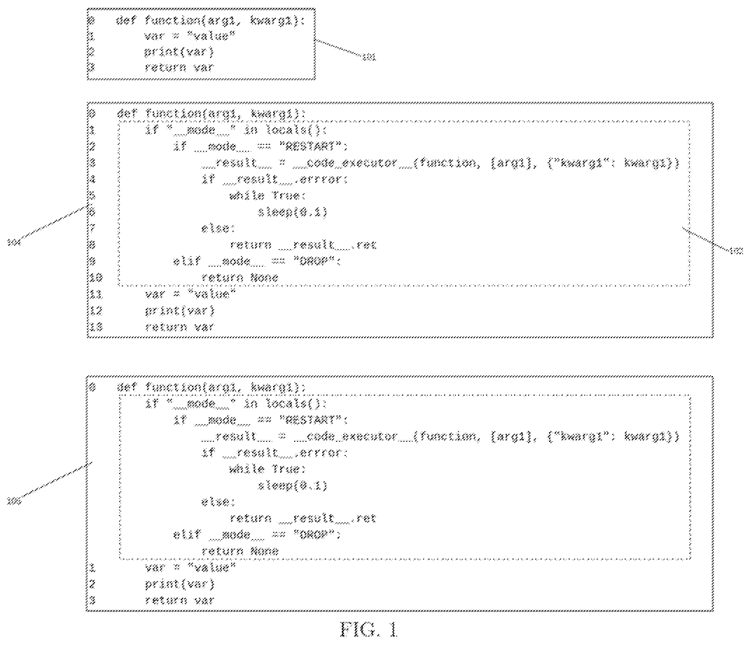

FIG. 1 shows an exemplary result of transforming original function source code 101 by at least one computing device. Source code comprising frame restarting instructions 102 is added to the original function source code 101. Addition of the source code 102 introduces unwanted bytecode to line numbers mapping 104.

The unwanted bytecode to line numbers mapping 104 is further transformed to conceal the frame restarting instructions and match the original source code 101. Transformation of bytecode to line number mappings in CPython implementation can be achieved by modifying entries of “co_lnotab” field of code objects or modifying “lineno” field for abstract syntax tree objects. Such transformation can be done by a person skilled in the art. An example result of the transformation can be seen in 105.

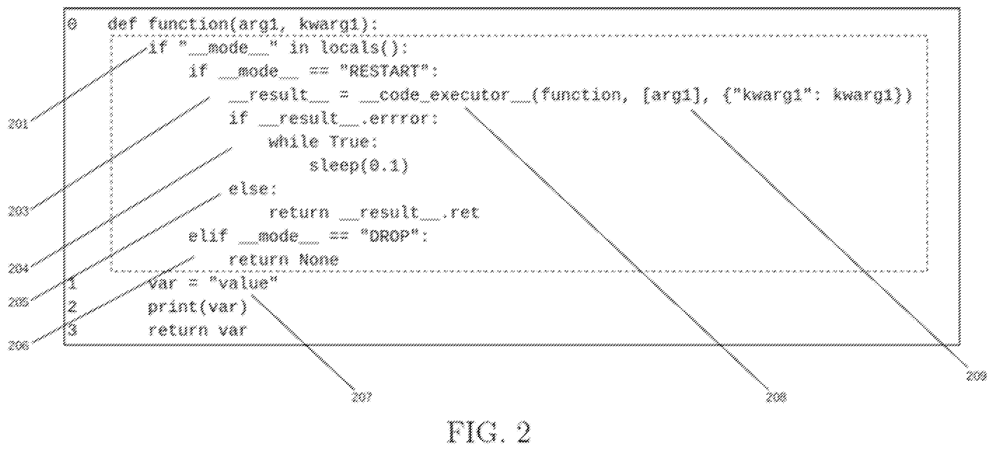

FIG. 2 shows an exemplary transformation of function code in detail according to an example of the instant disclosure.

Upon entering the function code, if statement 201 tests whether “_mode_” variable exists in the local scope. Since “_mode_” variable is not defined during regular code execution the test result is False.if statement 201 ensures the frame restarting instructions are not prematurely executed which would be unwanted at this point.

During the original code body 207 execution when a call stack frame control action is desired, variable “_mode_” is set to the corresponding action mode name by the handler process and an unconditional jump to if block 201 is performed. One of the ways to perform an unconditional jump in CPython is to change value of “f lineno” frame object field. Since variable “_mode_” has been defined, if test statement 201 value is True and code execution enters if block body 201.

Two frame control actions are implemented in this example including frame restarting 203 and frame dropping 206.

Frame restarting is implemented by calling code execution function 208 with original arguments 209 passed. Function 208 executes the original code or updated code if any changes are desired. Updated code can be transformed by the system to enable frame controlling capability for the call stack frame executing the updated code.

Following function call 208 a new call stack frame is created and the execution continues in the same fashion with frame restarting capabilities enabled as previously described.

In some cases code execution function 208 call may yield an exception due to software developer source code error or other means. The error is handled by function 208 and stored in a return object assigned to “_result_” variable. Subsequently, code execution is kept in while loop 204.

The error can be attempted to be fixed and the call stack frame restarted with the fixed code by performing an unconditional jump to 201 as previously described.

After the restarted frame execution reaches end of code body 207, the returned value is passed to “_result_” 203 object and returned in statement 205 during the stack unwinding. Return value of the topmost call stack frame execution is passed to the original call stack frame and subsequently returned from it. Frame dropping is implemented by simply returning None 206 effectively finishing execution of the frame.

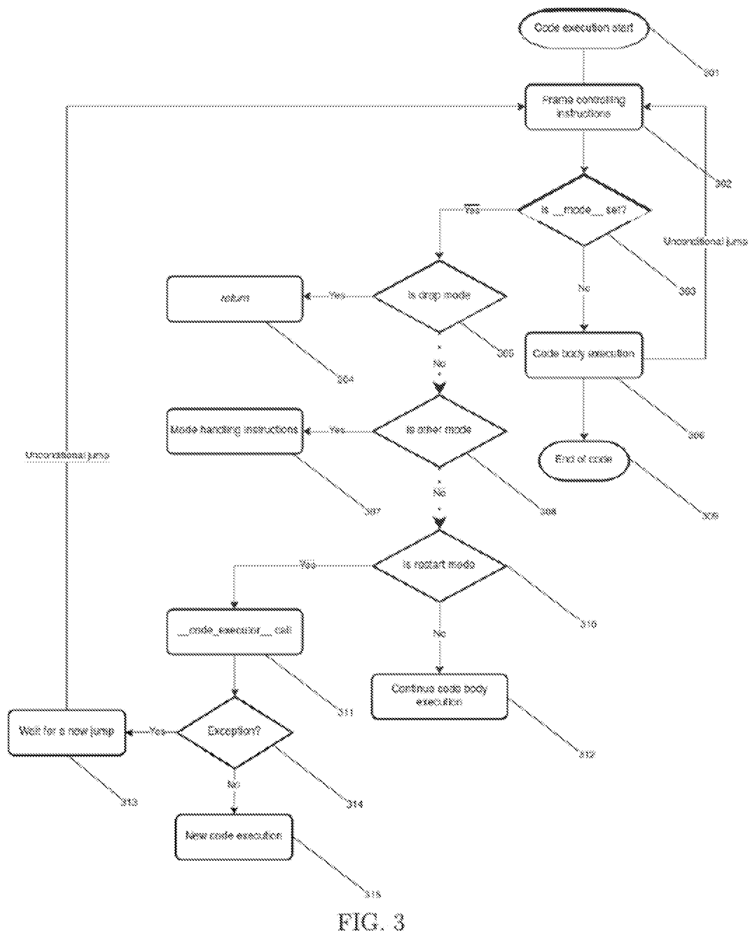

FIG. 3 presents a flow chart further explaining an exemplary flow of execution of transformed code according to an example of the instant disclosure. Code execution starts at the entrypoint 301. Next, frame controlling instructions 302 are beginning to be executed. If statement 303 tests whether “_mode_” variable is set to a value representing frame controlling action. If “_mode_” variable is not set the program continues execution to the main code body 306 where it finally reaches end of code 309.

In case “_mode_” variable is set a frame action is executed. Variable “_mode_” value determines which frame action is going to be executed. In one example, the drop mode frame action 305 is added. The drop mode frame action stops execution of a given frame and can be implemented by executing a return statement 304.

In another example, a custom frame action 308 is implemented by executing arbitrary code 307. In yet another example, the frame restart action 308 is added. The frame restart action is performed by calling “_code_executor_” function which starts executing the same or new code 315.

If an unhandled exception occurs 314 the execution can be held in 313 until a new frame action is requested by an unconditional jump to 302. In case there are no unhandled exceptions the execution continues in 315.

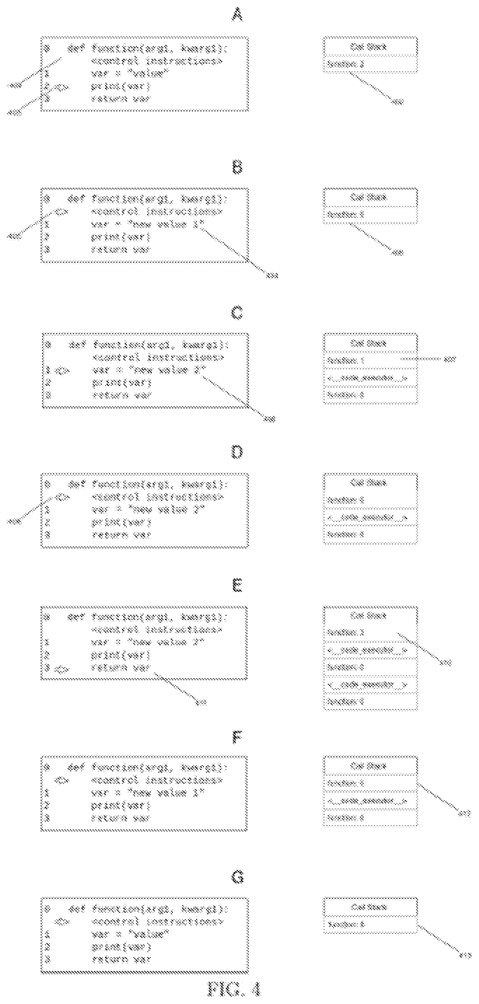

FIG. 4 shows an exemplary execution scenario of a transformed function according to an example of the instant disclosure. The current frame line number is depicted as arrows 403 and the call stack as tables 402. During the execution two frame restart actions will be performed, each with updated code.

This example explains how the system can help to debug a computer program by restarting call stack frames with updated code. Subsequent call stack frame restarts can be used to modify function behaviour or to fix found errors.

In A upon entering the function, the initial stack frame 402 is created and execution starts from line “0” 409 wherein frame controlling instructions had been added.

An exemplary implementation of frame controlling instructions shown in line 409 are shown in FIG. 1 and FIG. 2.

In A since “_mode_” is not set yet, the frame controlling instructions has not been executed and the current frame execution line is “2”.

The source code can be modified during the frame execution as the software engineer desires and the function code object can be updated. In this example in B value of “var” variable is changed by the user to “new value 1” 404. Code resulting in the update can be optionally transformed to enable capability of subsequent frame controlling.

In B changes will not be reflected in the current call stack frame since the original code is still being executed. Variable “_mode_” is set to “RESTART” followed by an unconditional jump to “0” line 405 wherein the frame restarting instructions are executed with the updated code by a proxy function “_code_executor_”.

In C the interpreter creates a new stack frame 407 and execution continues from line “0”. The frame controlling instructions are disabled at this time as well since “_mode_” variable is not set for this frame yet.

The change of variable “var” value to “new value 1” is reflected in execution of this frame since the updated code object is being executed. The source code can be further edited and in this example variable “var” is changed to “new value 2” 406.

In D another stack frame restart is performed by setting “_mode_” variable to “RESTART” followed by an unconditional jump to line “0” 408 and the updated code is executed by a proxy function “_code_executor_” call.

In E the interpreter creates a new stack frame 410 and a recursion can be observed. No more frame control actions will be performed in this exemplary execution. The frame execution reaches return statement 411 and return value “new value 2” is passed to the previous frame 412.

In F and G the value is passed to the original frame 413 and returned as a result to the original call site.

The value can be returned using a return statement shown as 205 FIG. 2 or any other means known to a person skilled in the art. Resulting return value of the original call 402 is “new value 2”.

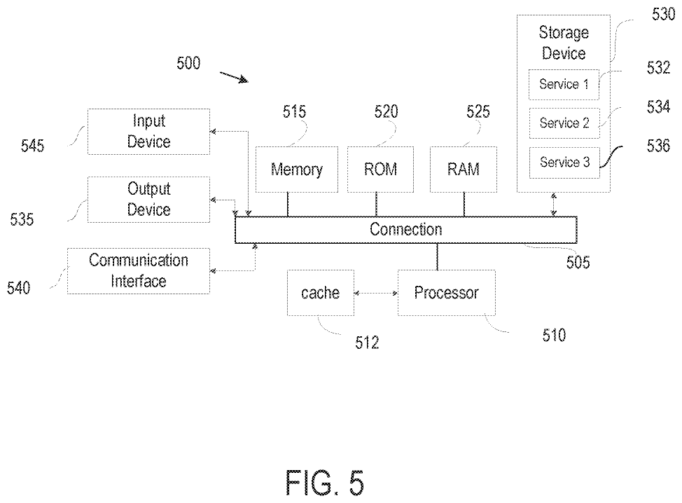

FIG. 5 shows an example of computing system 500, which can be for example any computing device making up the at least one computing device discussed herein, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A method for controlling execution of call stack frames in an actively running computing machine, the method comprising transforming, by at least one processor, code instructions by adding at least one frame controlling instruction, performing, by the at least one processor, an unconditional jump to a frame controlling instructions location, and executing, by the at least one processor, the at least one frame controlling instruction, whereby execution of the frame controlling instructions one of performs and assists controlling execution of call stack frames.

Aspect 2: The method of Aspect 1, wherein the transforming is performed on source code.

Aspect 3: The method of Aspects 1 and 2, wherein the transforming is performed on an abstract syntax tree.

Aspect 4: The method of Aspects 1 to 3, wherein the transforming is performed on bytecode.

Aspect 5: The method of Aspects 1 to 4, wherein bytecode offsets to line numbers mapping is transformed to conceal frame restarting instructions and match the original source code lines.

Aspect 6: The method of Aspects 1 to 5, wherein the at least one frame controlling instruction is conditionally disabled.

Aspect 7: The method of Aspects 1 to 6, wherein the unconditional jump is performed by a handler process or a tracing function.

Aspect 8: The method of Aspects 1 to 7, wherein the at least one frame controlling instruction comprises frame restarting instructions.

Aspect 9: The method of Aspects 1 to 8, wherein the at least one frame restarting instruction executes the original or updated code.

Aspect 10: The method of Aspects 1 to 9, wherein execution errors of the code are handled.

Aspect 11: The method of Aspects 1 to 10, wherein the updated code is transformed.

Aspect 12: The method of Aspects 1 to 11, wherein the at least one frame controlling instruction comprises frame dropping instructions.

Aspect 13: The method of Aspects 1 to 12, wherein the at least one frame controlling instruction comprises frame halting instructions.

Aspect 14: The method of Aspects 1 to 13, wherein the at least one frame controlling instruction comprises one or more calls to external libraries or systems.

Aspect 15: A system for controlling execution of call stack frames in an actively running computing machine, comprising a memory storing computer-readable instructions and at least one processor to execute the instructions to transform code instructions by adding at least one frame controlling instruction, perform an unconditional jump to a frame controlling instructions location, and execute the at least one frame controlling instruction, whereby execution of the at least one frame controlling instruction one of performs and assists controlling execution of call stack frames.

Aspect 16: The system of Aspect 15, wherein the transforming is performed on source code.

Aspect 17: The system of Aspects 15 and 16, wherein the transforming is performed on an abstract syntax tree.

Aspect 18: A non-transitory computer-readable storage medium, having instructions stored thereon that, when executed by at least one computing device cause the at least one computing device to perform operations for controlling execution of call stack frames in the at least one computing device, the operations comprising transforming code instructions by adding at least one frame controlling instruction, performing an unconditional jump to a frame controlling instructions location, and executing the at least one frame controlling instruction, whereby execution of the at least one frame controlling instruction one of performs and assists controlling execution of call stack frames.

Aspect 19: The non-transitory computer-readable storage medium of Aspect 18, wherein the transforming is performed on source code.

Aspect 20: The non-transitory computer-readable storage medium of Aspects 18 and 19, wherein the transforming is performed on an abstract syntax tree.

What is claimed is:

1. A method for controlling execution of call stack frames in an actively running computing machine, the method comprising:
transforming, by at least one processor, code instructions by adding at least one frame controlling instruction;
performing, by the at least one processor, an unconditional jump to a frame controlling instructions location; and
executing, by the at least one processor, the at least one frame controlling instruction,
whereby execution of the frame controlling instructions one of performs and assists controlling execution of call stack frames.

2. The method of claim 1, wherein the transforming is performed on source code.

3. The method of claim 1, wherein the transforming is performed on an abstract syntax tree.

4. The method of claim 1, wherein the transforming is performed on bytecode.

5. The method of claim 1, wherein bytecode offsets to line numbers mapping is transformed to conceal frame restarting instructions and match the original source code lines.

6. The method of claim 1, wherein the at least one frame controlling instruction is conditionally disabled.

7. The method of claim 1, wherein the unconditional jump is performed by a handler process or a tracing function.

8. The method of claim 1, wherein the at least one frame controlling instruction comprises frame restarting instructions.

9. The method of claim 8, wherein the at least one frame restarting instruction executes the original or updated code.

10. The method of claim 9, wherein execution errors of the code are handled.

11. The method of claim 9, wherein the updated code is transformed.

12. The method of claim 1, wherein the at least one frame controlling instruction comprises frame dropping instructions.

13. The method of claim 1, wherein the at least one frame controlling instruction comprises frame halting instructions.

14. The method of claim 1, wherein the at least one frame controlling instruction comprises one or more calls to external libraries or systems.

15. A system for controlling execution of call stack frames in an actively running computing machine, comprising:
a memory storing computer-readable instructions; and
at least one processor to execute the instructions to:
transform code instructions by adding at least one frame controlling instruction;
perform an unconditional jump to a frame controlling instructions location; and
execute the at least one frame controlling instruction, whereby execution of the at least one frame controlling instruction one of performs and assists controlling execution of call stack frames.

16. The system of claim 15, wherein the transforming is performed on source code.

17. The system of claim 15, wherein the transforming is performed on an abstract syntax tree.

18. A non-transitory computer-readable storage medium, having instructions stored thereon that, when executed by at least one computing device cause the at least one computing device to perform operations for controlling execution of call stack frames in the at least one computing device, the operations comprising:
transforming code instructions by adding at least one frame controlling instruction;
performing an unconditional jump to a frame controlling instructions location; and
executing the at least one frame controlling instruction, whereby execution of the at least one frame controlling instruction one of performs and assists controlling execution of call stack frames.

19. The non-transitory computer-readable storage medium of claim 18, wherein the transforming is performed on source code.

20. The non-transitory computer-readable storage medium of claim 18, wherein the transforming is performed on an abstract syntax tree.
